(19) United States
(12) Patent Application Publication
(10) Pub. No.: US 2001/0048280 A1
(43) Pub. Date: Dec. 6, 2001

(54) Motor control system for an automatic window of a vehicle

(76) Inventor: Robert H. Wilson, Farmington Hills, MI (US)

Correspondence Address: Matthew R. Mowers, Brooks & Kushman P.C., 1000 Town Center, 22nd Floor, Southfield, MI, 48075-1351, US

(21) Appl. No.: 09/751,030

(22) Filed: Dec. 29, 2000

Related U.S. Application Data
(60) Provisional application No. 60/174,438, filed on Jan. 4, 2000.

(51) Int. Cl. H02P 1/00

(52) U.S. Cl. 318/445

(57) ABSTRACT

A motor control system and method for detecting an obstruction for an automatic window of a vehicle include a window frame having an opening defined therebetween and a window pane disposed within the opening of the window frame. The motor control system includes a plurality of transmitters that emit an electromagnetic energy signal and a plurality of sensors which detect the signals in the opening of the window frame. A control module in communication with the plurality of transmitters and sensors processes the detected signals and transmits a signal to a drive motor to stop the upward travel of a window based on the detection of an obstruction between the window frame and the window pane.

### CROSS-REFERENCE TO RELATED APPLICATIONS

This application claims the benefit of U.S. provisional application Serial No. 60/1 74,438 filed Jan. 4, 2000.

### BACKGROUND OF THE INVENTION

1. Field of the Invention

The present invention relates to a motor control system for an automatic window closure of a vehicle and more particularly to an infrared anti-pinch system for sensing an obstruction between a “one-touch up” automatic window and a window frame of a vehicle door.

2. Background Art

Door assemblies for automotive vehicles generally include a metal door frame having inner and outer door frame panels attached to the body of a vehicle. The door frame includes a door sill running about a top edge of the door defining a window frame. The window frame includes an opening or vent extending through the door which receives a window pane. A reinforcement panel or member may be attached to the inner door panel to provide additional structural support for the door frame and to receive and support various hardware components. Hardware components such as a handle assembly, window regulator and motor assembly, and electrical components such as interior lights and speakers, are secured to the reinforcement panel concurrently with assembly of the vehicle door.

Certain vehicle door assemblies include automatic vehicle window adjustment having a “one-touch up” feature. With the “one-touch up” feature, a single touch of a control button on the vehicle door actuates the motor assembly to raise the window pane connected to a window regulator. The motor assembly, which is operatively connected to the window regulator, raises the window pane upward toward the top of the window frame to a fully closed position without additional operator intervention. A problem with such “one-touch” systems is that an object may become pinched or trapped between the moving window and the window frame without the intervention of the occupant of the vehicle, causing significant bodily harm.

Several types of obstruction detection systems have been proposed for vehicle door assemblies. One known obstruction detection system includes a control module which senses current spikes in the window drive motor or pressure on the window which would indicate an obstruction being pinched between the upward moving window and the window frame. The obstruction detection system stops and/or reverses the motor upon sensing the current spike or increased pressure while raising the motor. The problem with this design is that an object must be trapped or pinched with sufficient force for the system to sense the need to reverse the motor and lower the window, causing undesirable injury to an occupant prior to the lowering of the window.

Another known obstruction detection or anti-pinch system includes a window seal with a gasket having varying resistivity based upon its level of compression. For example, if an obstruction is pinched between the window and the window frame, the gasket is locally compressed, which alters the resistivity of the gasket. A low current is applied through the gasket, and the variation in resistivity may be sensed to determine the existence of the obstruction, at which point upward movement of the window would be stopped. The system is not particularly desirable because the resistive gasket and associated electronics may be costly and injury may still occur prior to the lowering of the window.

Another obstruction detection system includes an optical or acoustic wave having a transmitter and sensor mounted at opposite corners of the opening of the window. A wave is transmitted through the opening between the transmitter and sensor. When an object enters into the opening between the window and door frame, the sensor senses an interruption in the transmission and signals the control module to terminate the raising of the window pane. This system requires the use of mirrors or other reflective devices to transmit the wave between the transmitter and sensor about the periphery of the opening in the vehicle door. The refractive devices may become misaligned or fail to reflect the signals over the life of operation, potentially causing false signals or failing to stop the upward travel of the window altogether.

Accordingly, it is desirable to provide an improved motor control system for an automatic window of a vehicle having anti-pinch detection which prevents an obstruction from becoming trapped or lodged between a window and a window frame in the opening of the vehicle door during the “one-touch up” window operation. It is also desirable to provide a motor control system which senses an obstruction prior to contact between an obstruction and the window.

### SUMMARY OF THE INVENTION

Therefore, it is an object of the invention is to provide a motor control system for an automatic window of a vehicle which prevents an object from becoming trapped between the window and window frame during the upward travel of the window.

Another object of the invention is to provide a motor control system for an automatic window of a vehicle using a plurality of optical wave transmitters and sensors to detect the presence of an object between the window and door frame which are coupled to a control module which prevents the window from trapping the obstruction.

A further object of the invention is to provide a method of detecting an obstruction between an automatic window and a window frame of a vehicle door using a optical waves transmitted between a plurality of transmitters and sensors.

Yet another object of the invention is to provide a motor control system which does not require contact between the obstruction and the window pane or frame.

The present invention overcomes the above-referenced shortcomings of prior art obstruction detection systems by providing a motor control system in combination with a vehicle door assembly having an automatic window. The vehicle door assembly includes a window frame having an upper portion, a lower portion, a front portion and a rear portion and an opening defined therebetween. A window is disposed on a window carrier assembly mounted to the vehicle door. The window is vertically adjustable through the inner periphery of the opening of the window frame by a drive motor operatively connected to the window carrier assembly.

The motor control system of the door assembly includes a plurality of transmitters disposed about the opening of the door frame which emit an electromagnetic energy signal, such as infrared light. A plurality of sensors are disposed about the opening of the door frame to detect the electromagnetic energy signals. In one embodiment of the invention, a first transmitter and sensor are mounted adjacent the upper portion of the window frame to monitor a first area of the opening, while a second transmitter and sensor are mounted adjacent the front portion of the window frame to monitor a second area of the opening for obstructions.

A control module is provided in communication with the plurality of transmitters and sensors to detect the presence of an obstruction in the opening of the window frame based on an interruption in the signals detected by the plurality of sensors. The control module compares the signals detected by the sensors to stored values in the control module to determine whether an obstruction is present in the opening in the window frame. Upon detection of an obstruction, the control module transmits a signal to the drive motor to terminate the upward travel of the window in the window frame.

In an alternative embodiment, the motor control system includes a photointerrupter mounted adjacent the first monitoring system in communication with the control module to detect the position of the window relative to a window frame.

A method of detecting an obstruction for a window assembly in a vehicle door is also disclosed. A motor control system is provided to monitor an opening defined in the inner periphery of a window frame when the window travels upward through the window frame. The motor control system includes a plurality of transmitters to emit an electromagnetic energy signal into the opening of the window frame. A plurality of sensors are disposed about the periphery of the opening in the window frame to detect the electromagnetic signals.

A control module processes the electromagnetic energy signals detected by the plurality of sensors and compares the signals to predetermined stored values in the control module to detect the presence of an obstruction in the opening of the window frame. If an obstruction is detected, the control module transmits a signal to the drive motor to terminate the upward travel of the to allow an occupant to remove the obstruction from the opening. The method further comprises a hardware fault detection system which sends a pulse of electromagnetic energy to the sensors from the transmitters to test the motor control system during the downward travel of the window in the window frame.

The above objects and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a perspective view of a vehicle door assembly including a motor control system of the present invention;

FIG. 2 is a schematic view of the motor control system of the present invention;

FIG. 3 is a schematic view of the motor control system detecting the presence of an obstruction in accordance with the present invention; and

FIG. 4 is a block diagram of the method of detecting an obstruction in a window frame of a vehicle door of the present invention.

### DETAILED DESCRIPTION OF THE PREFERRED EMBODIMENT(S)

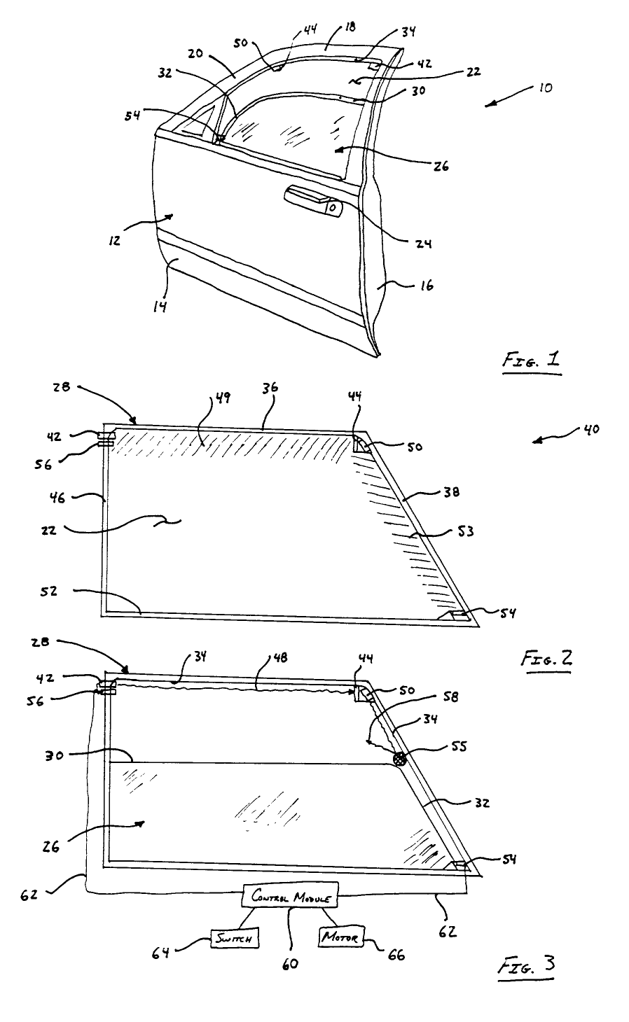

Referring to FIG. 1, a description of the motor control system of the present invention is discussed in greater detail. A vehicle door assembly 10 includes a vehicle door frame 12 having an outer door panel 14 and an inner door panel 16. Inner and outer door panels 14, 16 are generally vertical panels formed of a stamped sheet metal which are joined to form vehicle door frame 12. Alternatively, vehicle door frame 12 may be formed as a one piece structure. The vehicle door frame 12 includes a header section 18 having a door sill 20 forming a window frame 28. An opening or vent 22 is provided adjacent window frame 20 and extends through inner and outer door panels 14, 16 in vehicle door frame 12. A handle 24 is mounted in the outer door panel 14.

Door assembly 10 may include a structural member or carrier (not shown) mounted to the inner door panel 14 to provide structural support for the vehicle door frame 12 and to receive a plurality of components. Alternatively, the interior vehicle components may be directly secured to the door frame 12. A window carrier assembly is mounted to the carrier on door frame 12 to receive and support a pane of window glass 26. Window carrier assembly generally includes a window regulator and a motor operatively connected to the window regulator to vertically adjust window pane 26.

In a preferred embodiment of the invention, window pane 26 is secured to a generally horizontal support arm extending between a pair of generally vertical spaced apart rails. The support arm is set in a track extending through each of the vertical arms of the window regulator. A pair of cables operatively connected to the motor raise and lower the support arm to adjust the vertical position of window pane 26.

The window pane 26 moves vertically with respect to a window frame 28, which is integral with vehicle door frame 12. A seal extends through the inner periphery of a cavity in window frame 28 to receive the upper edges 30, 32 of window pane 26. The seal, which is preferably formed of a rubber or other polymeric material, ensures a waterproof and soundproof seal for the interior passenger compartment of the vehicle by sealing the upper edges 30, 32 of window pane 26 and the inner periphery 34 of window frame 28 respectively.

Referring additionally now to FIGS. 2 and 3, a motor control system, generally referenced by numeral 40, includes a plurality of transmitters 42 and a plurality of sensors 44. Transmitters 42 and sensors 44 are provided on the inner door panel 16 of door frame 12 adjacent opening 22 to a monitor the opening 22 of window frame 28 for the motor control system 40. The sensors 44 is positioned coplanar to the transmitter 42 on door frame 12 to detect and interpret a signal or transmission from the transmitters 42. The transmitters 42 and sensors 44 monitor a distinct area defined by the opening 22 between the inner periphery 34 of window frame 28 and the outer edges 30, 32 of window pane 26. A control module is in communication with the transmitters 42 and sensors 44 to process the signals detected by the sensors and terminate the upward travel of the window pane 26 if an obstruction is detected between the window pane 26 and window frame 28.

In a preferred embodiment of the invention, the motor control system 40 includes a first transmitter 42 mounted adjacent a rear portion 46 of the window frame 28. The first transmitter sends a electromagnetic energy signal, such as directed infrared light, or an ultrasound wave 48, along inner periphery 34 of the window frame adjacent the upper portion of window frame 28. A first sensor 44 is positioned coplanar to the first transmitter 42 on the upper portion 36 of window frame 28 adjacent the opening 22. The first transmitter 42 and first sensor 44 in combination monitor a first area, generally represented by numeral 49, of the opening 22 of window frame 28 for obstructions during the upward travel of the window.

A second transmitter 50 is mounted adjacent first sensor 44 on a front portion 38 of window frame 28. Second transmitter 50 is directed toward a lower portion 52 of window frame along the inner periphery of the front portion 38 of window frame towards a second sensor 54. Second sensor 54 is disposed coplanar to the second transmitter 50 adjacent the inner periphery 34 of window frame 28. The second transmitter 50 and second sensor 54 in combination monitor a second area, generally represented by numeral 53, of the opening 22 adjacent the front portion 38 of window frame 28.

First and second transmitters 42, 50 of motor control system 40 are designed to emit infrared light 48 that is laser thin so as to be unnoticeable to the operator. First and second sensors 44, 54 are direction sensitive and are disposed on the window frame 28 relative to the first and second transmitters 42, 50 so that sunlight or other ambient light does not interfere with the infrared light 48 transmitted between the transmitters and sensors. In a preferred embodiment of the invention, first and second transmitters 42, 50 are slightly offset with respect to the lower edges of window frame 28 to ensure that the presence of window pane 26 is not mistakenly determined to be an obstruction.

Alternatively, if the first and second transmitters 42, 50 are not slightly offset from the edges of the window frame, a photointerrupter 56 may be used to deactivate the motor control system 40. The photointerrupter 56 senses the location of the window pane 26 as the window pane approaches the inner periphery 34 of window frame 28. The photointerrupter 56 senses the position of the window pane 26 to ensure that the window 26 is not detected as an obstruction 55. Alternatively, fiber optics could be used to send and receive infrared light, and communicate with the control module.

First and second transmitters 42, 50 emit infrared light 48 in a square wave pattern having a determined wavelength to first and second sensors 44, 54. First transmitter 42 and sensor 44 monitor a first zone of opening 22 adjacent the top edge 30 of window pane 26 while second transmitter 50 and sensor 54 monitor a second distinctive zone of opening 22 adjacent front edge 32 of window pane 26. The first and second sensors 44, 54 are adapted to detect any variation in the transmission of infrared light 48 from the first and second transmitters 42, 50 respectively.

A description of the operation of the motor control system 40 is provided in greater detail. Referring now to FIG. 3, an obstruction 55 in the opening 22 adjacent the inner periphery 34 of window frame 28 deflects the transmission of infrared light 58 from second transmitter 50 to second sensor 54. As a result of the obstruction, the second sensor 54 does not receive a signal from transmitter 50. Control module 60 detects the interruption in signal at second sensor 54 as the presence of an obstruction 55 in opening 22 of window frame 28.

Control module, represented schematically by block 60, is in communication with the first and second monitoring systems and photointerrupter 56 through connections, generally referenced by numeral 62. The control module 60 monitors the condition of the first and second sensors 44, 54 at time intervals to determine whether any interruptions in the transmission of light from the first and second transmitters 42, 50 has been detected. Additionally, control module 60 is in communication with switching mechanism, represented schematically by block 64. Switching mechanism 64 is manipulated by an operator to provide a “one-touch up” feature. The “one-touch up” feature allows an operator to raise the window simply by depressing the switch for a specific time interval. The control module 60, upon receiving this signal will raise the window pane 26 into the window frame 28 unless an obstruction is detected.

Upon detection of an interruption of light between a transmitter and a sensor, control module 60 transmits a signal to the motor of window carrier assembly, represented schematically by block 66, to stop the upward travel of the window pane 26. Additionally, control module 60 may be programmed to command the motor to lower the window pane 26 to allow the operator to remove obstruction 54 from the monitored zone in opening 22 of window frame 28.

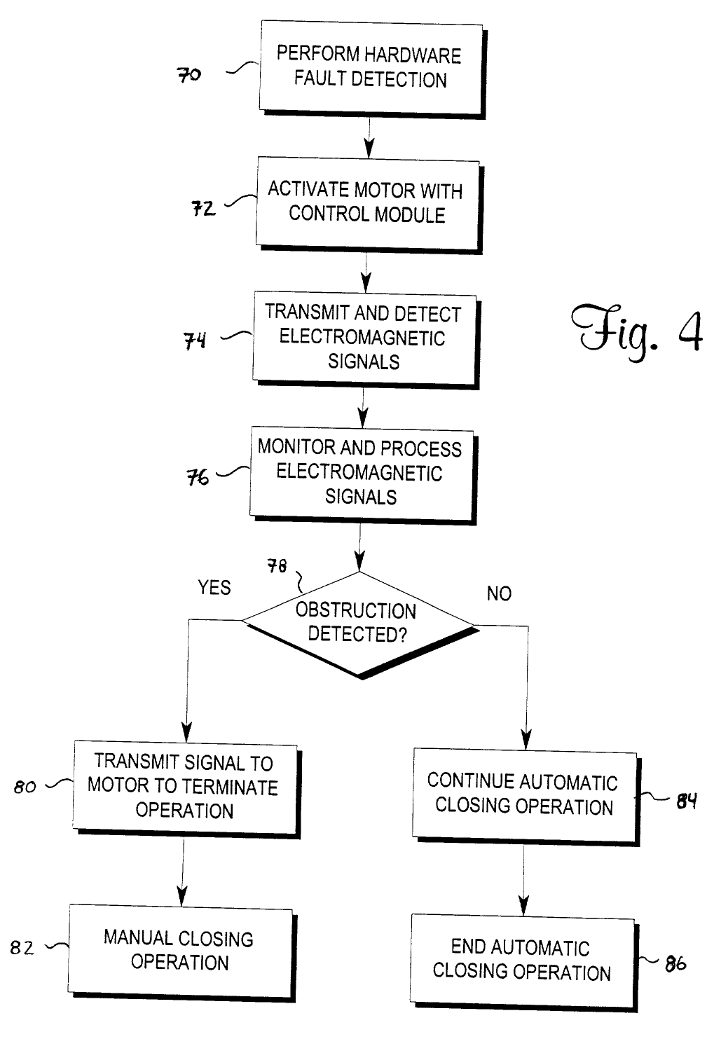

Referring now to FIG. 4, a description of the method of detecting the presence of an obstruction in a power vehicle window system will be described in greater detail. Microprocessor of the control module performs a hardware fault detection at block 70. The microprocessor sends a signal to pulse the first and second transmitters 42, 50 during a “down” operation, or the downward travel of the window pane 26. If the infrared light signals from transmitters 42, 50 are detected as interrupts on both the first and second sensors 44, 54, the microprocessor will consider the motor control system 40 functional. If no interrupts are detected, the control module 60 will alarm the driver via a dash light or some other means that a system fault has been detected in the motor control system 40. This provides a failsafe mechanism to determine the existence of a fault, such as mud on the sensors or a broken transmitter.

In operation, a microprocessor receives an input 72 from switching mechanism 64 to activate the “one-touch up” window feature. Upon receipt of this signal from switching mechanism 64, the microprocessor of control module 60 sends a signal to the drive motor of the window regulator to initiate the upward travel of the window. Control module 60 further activates the motor control system 40 at block 74. The first and second transmitters 42, 50 emit electromagnetic energy signals while the first and second sensors 44, 54 detect the signals in the opening 22 of window frame 28 to detect the presence of any obstructions between window pane 26 and window frame 28.

The microprocessor of control module 60 detects and processes interrupt signals from input capture ports of the first and second sensors 44, 54 at block 76. The microprocessor is programmed to allow the window to be raised if an expected number of interrupts occur to determine that the window is unobstructed until the next software cycle. The software program includes predetermined stored values for expected signal rates and times during the upward travel of the window.

If the software program run by the microprocessor does not detect a specific number of interrupts programmed to occur in a time interval, shown at block 78, then the microprocessor will assume an obstruction exists between the window pane 26 and window frame 28. The microprocessor of control module 60 will then stop the “one-touch up” operation by sending an instruction 80 to the motor of window carrier assembly 66 to stop the upward travel of the window, lower the window in the window frame and return the window to a manual mode of operation from the “one-touch” mode 82. The microprocessor may also initiate a signal to chime an alarm to warn the driver of an obstruction. If the control module senses a set number of interrupts in a time interval, shown at block 84, then the window pane 26 will continue its upward travel toward window frame 28. This cycle continues until the window reaches a fully closed position 86.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A motor control system to avoid an obstruction in a window opening in a vehicle door, the motor control system comprising:
a plurality of transmitters disposed about the opening of the door frame for emitting an electromagnetic energy signal;
a plurality of sensors disposed about the opening of the door frame for detecting the electromagnetic energy signal emitted by the plurality of transmitters; and
a control module in communication with the plurality of sensors to detect the presence of an obstruction in the opening of the window frame based on an interruption in the signals detected by the plurality of sensors, wherein the control module transmits a signal to a drive motor operatively connected to a window terminate the upward travel of the window in the window frame upon detecting an obstruction between the plurality of transmitters and sensors.

2. The motor control system of claim 1 wherein the control module compares the electromagnetic energy signals detected by the first and second sensors to stored values in the control module over an interval of time during the upward travel of the window to determine the presence of an obstruction in the opening of the window frame.

3. The motor control system of claim 1 wherein each of the plurality of sensors is disposed opposite to and coplanar with each of the plurality of transmitters to monitor an area of the opening of the window frame.

4. The motor control system of claim 1 further comprising a first transmitter disposed adjacent an upper portion of the window for transmitting the electromagnetic energy signal and a first sensor disposed opposite to and coplanar with the first transmitter for detecting the electromagnetic energy signal.

5. The motor control system of claim 1 further comprising a second transmitter disposed adjacent an upper portion of the window for transmitting the electromagnetic energy signal and a second sensor disposed opposite to and coplanar with the second transmitter for detecting the electromagnetic energy signal.

6. The motor control system of claim 1 wherein the control module independently monitors the first and second areas of the opening of the window frame for obstructions detected between the first transmitter and sensor and the second transmitter and sensor.

7. The motor control system of claim 1 wherein the electromagnetic energy signal emitted by the first and second transmitters is an infrared energy signal.

8. The motor control system of claim 7 wherein the electromagnetic energy signal emitted by the first and second transmitters is a narrow beam of infrared energy directed at the first and second sensors of the motor control system.

9. The motor control system of claim 1 wherein the signal emitted by the first and second transmitters is an ultrasound wave.

10. The motor control system of claim 1 wherein the system further comprises a photointerrupter in communication with the control module to detect the position of the window relative to the window frame.

11. The motor control system of claim 10 wherein the photointerrupter is provided adjacent the first transmitter to detect the position of the window relative to the window frame.

12. A door assembly for a vehicle having an automatic window including a motor control system to avoid an obstruction in a window opening, the door assembly comprising:
a vehicle door frame; a window frame formed in the door frame, the window frame having an upper portion, a lower portion, a front portion, a rear portion and an opening defined therebetween;
a window carrier assembly mounted to the door frame, the window carrier assembly including a window regulator having a pair of spaced apart generally vertical rails, a generally horizontal support arm extending between the rails and a motor in communication with the support arm which vertically adjusts the position of the support arm;
a window secured to the support arm of the window regulator, wherein the window is vertically adjustable through an inner periphery of the window frame;
a first transmitter mounted adjacent the upper portion of the window frame for transmitting an electromagnetic energy signal;
a first sensor mounted coplanar to the first transmitter along the upper portion of the window frame to detect the electromagnetic energy signal emitted by the first transmitter for monitoring a first area of the opening in the vehicle door;
a second transmitter mounted adjacent the front portion of the window frame for transmitting an electromagnetic energy signal;
a second sensor mounted coplanar to the second transmitter along the front portion of the window frame to detect the electromagnetic energy signal emitted by the second transmitter; and
a control module in communication with the first and second transmitters and sensors to detect an interruption in signals between the transmitter and sensor, wherein the control module transmits a signal to the motor to terminate the upward travel of the window based on the detection of an obstruction in one of the first and second areas of the opening of the window frame.

13. The door assembly of claim 12 further comprising a switching mechanism coupled to the control module to transmit commands to the control module to raise or lower the window in the window frame.

14. The door assembly of claim 13 wherein the switching mechanism further comprises a one-touch feature which allows a single activation of the switching mechanism to actuate the control module to raise the window pane to the window frame.

15. The door assembly of claim 12 wherein the system further comprises a photointerrupter in communication with the control module to detect the position of the window relative to a window frame.

16. The door assembly of claim 15 wherein the photointerrupter is provided adjacent the first monitoring system to detect the position of the window relative to the window frame.

17. The door assembly of claim 12 wherein the electromagnetic energy signal emitted by the first and second transmitters is an infrared energy signal.

18. The door assembly of claim 12 wherein the control module compares the electromagnetic energy signals detected by the first and second sensors to stored values in the control module over an interval of time during the upward travel of the window to determine the presence of an obstruction in the opening of the window frame.

19. The door assembly of claim 12 wherein the control module independently monitors the first and second areas of the opening of the window frame for obstructions detected between the first transmitter and sensor and the second transmitter and sensor.

20. A method of detecting an obstruction in a window assembly of a vehicle door, the method comprising the steps of:
providing a motor control system to monitor an opening defined in a window frame, the motor control system including a plurality of transmitters for transmitting an electromagnetic energy signal, a plurality of sensors for detecting the electromagnetic energy signals and a control module in communication with the plurality of transmitters and sensors to monitor signals detected by the sensors to sense the presence of obstructions in the opening of the window frame during the upward travel of the window;
activating a drive motor to initiate the upward travel of the window in the window frame;
activating the motor control system when the drive motor initiates the upward travel of the window in the window frame;
emitting electromagnetic energy signals with the plurality of transmitters into the opening of the window frame;
detecting electromagnetic energy signals with the plurality of sensors;
processing the signals detected by the plurality of sensors with the control module; and
transmitting a signal to the drive motor to terminate the upward travel of the window based upon detection of an obstruction in the opening by the motor control system between the window and the window frame.

21. The method of claim 20 wherein the step of processing the signals detected by the plurality of sensors with the control module further comprises the step of comparing the signal interrupts received by the first and second sensors with the control module to stored values to detect the presence of an obstruction in the first and second areas of the opening of the window frame.

22. The method of claim 20 wherein the step of emitting electromagnetic energy signals with the plurality of transmitters further comprises emitting infrared light signals with the plurality of transmitters into the opening of the window frame.

23. The method of claim 20 further comprising the step of performing a hardware fault detection of the motor control system during downward travel of the window in the window frame.

24. The method of claim 23 wherein the step of performing a hardware fault detection of the motor control system includes sending a pulse of infrared light from the plurality of transmitters to the plurality of sensors test the motor control system.
